(19) United States
(12) Patent Application Publication
(10) Pub. No.: US 2010/0211690 A1
(43) Pub. Date: Aug. 19, 2010

(54) BLOCK PARTITIONING FOR A DATA STREAM

(75) Inventors: Payam Pakzad, Mountain View, CA (US); Michael G. Luby, Berkeley, CA (US)

Correspondence Address: QUALCOMM INCORPORATED, 5775 MOREHOUSE DR., SAN DIEGO, CA, 92121, US

(73) Assignee: Digital Fountain, Inc., San Diego, CA (US)

(21) Appl. No.: 12/705,202

(22) Filed: Feb. 12, 2010

Related U.S. Application Data
(60) Provisional application No. 61/152,551, filed on Feb. 13, 2009.

(51) Int. Cl. G06F 15/16

(52) U.S. Cl. 709/231

(57) ABSTRACT

A method for serving a data stream from a transmitter to a receiver includes: determining an underlying structure of the data stream; determining at least one objective, selected from a group of (1) reducing a start-up delay between when the receiver first starts receiving the data stream from the transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and transmitting the blocks of the data stream consistent with the at least one objective and the underlying structure.

### CROSS-REFERENCES TO RELATED APPLICATIONS

This application claims the benefit of U.S. Provisional Application No. 61/152,551, entitled “Optimal Block Partitioning Methods for a Data Stream,” filed Feb. 13, 2009, assigned to the assignee hereof, and is hereby expressly incorporated by reference herein for all purposes.

### BACKGROUND

The present disclosure relates to streaming of media or data, and in particular to block partitioning.

In streaming applications, it is often critical to be able to use received data with a minimum amount of delay. For example, when streaming media, a receiver needs to be able to start playing the media as soon as possible, and the playback should not be interrupted later in the stream due to foreseeable events of data insufficiency. Another important constraint in streaming applications is the need to minimize or reduce transmission bandwidth used to send the stream. This need can arise because, for example, the available bandwidth is limited, sending at a higher bandwidth is more expensive, or competing flows of data share the available bandwidth.

In many streaming applications, the data stream has an underlying structure that determines how it can be consumed at a receiver. For example, in video streaming, the data stream might include a sequence of frames of data. The data in each frame is used to display the video frame at a particular point in time, where displaying a video frame is considered to be consuming the data stream. For efficient video compression, a frame of data can depend on other frames of data that display similar looking video frames. The sending order of the data for the frames might be different from the display order of the frames, i.e., the data for a frame is typically sent after sending all the data of frames on which it depends, directly and indirectly. To provide uninterrupted consumption of the data stream in these types of streaming applications, the display of consecutive video frames might need to be spaced at very fixed time intervals (e.g., at 24 frames per second), and all the data in a stream that is needed to display a frame needs to arrive at a receiver before the display time for that frame. Thus, the underlying structure of the data stream combined with the consumption model of the data at a receiver determines when the data needs to arrive at a receiver for uninterrupted consumption of the data stream.

In streaming applications, it is often advantageous to partition the original stream of data into blocks. For example, when streaming over a link with packet loss, a forward error correcting (FEC) code can be applied to each block to provide protection against packet loss or errors. As another example, an encryption scheme can be applied to each block to secure the transmission of the stream over an exposed link. In such situations, it is advantageous to partition the stream into blocks that satisfy certain block objectives, e.g., when applying FEC, to be able to provide the maximum protection possible at the cost of using additional bandwidth for FEC transmission, or when applying encryption, to be able to spread out the processing requirements for decryption at the receiver.

In these applications, it is often the case that the data stream is available for consumption in units of entire blocks at a receiver. That is, the data within a block is not available for consumption at the receiver until all the data comprising that block is available at the receiver. Thus, a block partitioning method can affect a startup delay and the transmission bandwidth needed to achieve uninterrupted consumption of the data stream, as well as other aspects of transmission and consumption of data streams.

What is needed are block partitioning methods that satisfy block objectives while at the same time achieving a minimal start-up delay and using minimal transmission bandwidth to achieve uninterrupted consumption of the data stream.

In some streaming applications, a receiver may need to be able to join and start consuming a data stream from any one of a number of starting points within the stream. Thus, what is also needed are block partitioning methods that satisfy the above objectives and also allow the receiver to start consuming a data stream from any one of a number of starting points within the stream.

### SUMMARY

An exemplary method for serving a data stream from a transmitter to a receiver according to the disclosure includes: determining an underlying structure of the data stream; determining at least one objective, selected from a group of (1) reducing a start-up delay between when the receiver first starts receiving the data stream from the transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and transmitting the blocks of the data stream consistent with the at least one objective and the underlying structure.

Embodiments of such a method may include the feature wherein the predetermined block constraints include a constraint that each block is of size greater than a given minimum block size and less than a given maximum block size.

An exemplary method for determining a block partition for serving a data stream of bits from a transmitter to a receiver includes: defining a start position of a first block of the data stream as a first bit position in the data stream; iteratively determining for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block; defining an end-point of the last block of the data stream as the first bit position after the last bit position of the data stream; for each block, from a block before the last block to the first block of the data stream, determining an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block, and defining an end-point of the present block of the data stream as a bit position in the intersection; and determining the block partition as the end-points of each block in the data stream.

Embodiments of such a method may include one or more of the following features. The last possible block of the data stream is determined from a size of the data stream and a minimum block size for the blocks of the data stream. The data stream is defined by a cumulative stream size function, and a communication link for serving the data stream is defined by a cumulative link capacity function; and the block partition is determined with a reduced start-up delay for uninterrupted presentation of the data stream, given the cumulative stream size function and the cumulative link capacity function. The data stream is defined by a cumulative stream size function, and a target start-up delay is determined for serving the data stream; and the block partition is determined with a reduced transmission bandwidth that ensures uninterrupted presentation of the data stream, given the cumulative stream size function and the target start-up delay. A communication link for serving the data stream is defined by a cumulative link capacity function, and a target start-up delay is determined for serving the data stream; and the block partition is determined with a highest quality encoding of the data stream, from a set of possible encodings, that ensures uninterrupted presentation of the data stream, given the cumulative link capacity function and the target start-up delay.

An exemplary method for determining a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, includes: dividing the data stream into a plurality of seek-blocks, each seek-block defined by a respective local cumulative stream size function, wherein data on one side of a particular seek-point is decoding independent of data on another side of the particular seek-point; recursively defining, for each seek-block of the plurality of seek-blocks, a respective effective start-up delay that is less than or equal to the predetermined start-up delay; determining, for each seek-block of the plurality of seek-blocks, a local block partition that ensures uninterrupted presentation of the respective seek-block with the respective effective start-up delay; and determining the global block partition as the local block partitions of each seek-block of the plurality of seek-blocks in the data stream.

An exemplary server for serving a data stream includes: a processor configured to determine an underlying structure of the data stream, and to determine at least one objective, selected from a group of (1) reducing a start-up delay between when a receiver first starts receiving the data stream from a transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and a transmitter coupled to the processor and configured to transmit the blocks of the data stream consistent with the at least one objective and the underlying structure.

Embodiments of such a server may include one or more of the following features. The predetermined block constraints include a constraint that each block is of size greater than a given minimum block size and less than a given maximum block size. The data stream includes video content, and the blocks of the data stream are transmitted using User Datagram Protocol.

An exemplary server for determining a block partition for serving a data stream of bits from a transmitter to a receiver includes a processor configured to define a start position of a first block of the data stream; determine a last block of the data stream by iteratively determining for each block, from the first block to a last possible block of the data stream, a first set of candidate start positions of a next consecutive block following a present block; define an end-point of the last block of the data stream; iteratively defining, for each block, from a block before the last block to the first block of the data stream, an end-point of a present block of the data stream as a bit position in an intersection of the first set and a second set of candidate start positions of a next consecutive block following the present block; and determine the block partition as the end-points of each block in the data stream.

Embodiments of such a server may include one or more of the following features. The server includes a memory coupled to the processor for storing the first set of candidate start positions. The server includes a storage device coupled to the processor for storing content to be served as the data stream. The data stream is defined by a cumulative stream size function, and a communication link for serving the data stream is defined by a cumulative link capacity function; and the block partition is determined with a reduced start-up delay for uninterrupted presentation of the data stream, given the cumulative stream size function and the cumulative link capacity function. The data stream is defined by a cumulative stream size function, and a target start-up delay is determined for serving the data stream; and the block partition is determined with a reduced transmission bandwidth that ensures uninterrupted presentation of the data stream, given the cumulative stream size function and the target start-up delay. A communication link for serving the data stream is defined by a cumulative link capacity function, and a target start-up delay is determined for serving the data stream; and the block partition is determined with a highest quality encoding of the data stream, from a set of possible encodings, that ensures uninterrupted presentation of the data stream, given the cumulative link capacity function and the target start-up delay.

An exemplary server for determining a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, includes a processor configured to divide the data stream into a plurality of seek-blocks, each seek-block defined by a respective local cumulative stream size function, wherein data on one side of a particular seek-point is decoding independent of data on another side of the particular seek-point; recursively define, for each seek-block of the plurality of seek-blocks, a respective effective start-up delay that is less than or equal to the predetermined start-up delay; determine, for each seek-block of the plurality of seek-blocks, a local block partition that ensures uninterrupted presentation of the respective seek-block with the respective effective start-up delay; and determine the global block partition as the local block partitions of each seek-block of the plurality of seek-blocks in the data stream.

An exemplary computer program product includes a processor-readable medium storing processor-readable instructions configured to cause a processor to: determine an underlying structure of a data stream; determine at least one objective, selected from a group of (1) reducing a start-up delay between when a receiver first starts receiving the data stream from a transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and determine a block partition for serving the data stream from the transmitter to the receiver, wherein the block partition ensures that transmitting and receiving the blocks of the data stream is consistent with the at least one objective and the underlying structure.

Embodiments of such a computer program product may include the feature wherein the predetermined block constraints include a constraint that each block is of size greater than a given minimum block size and less than a given maximum block size.

An exemplary computer program product includes a processor-readable medium storing processor-readable instructions configured to cause a processor to: define a start position of a first block of a data stream as a first bit position in the data stream; iteratively determine for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block; define an end-point of the last block of the data stream as the first bit position after the last bit position of the data stream; for each block, from a block before the last block to the first block of the data stream, determine an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block, and define an end-point of the present block of the data stream as a bit position in the intersection; and determine the block partition as the end-points of each block in the data stream.

Embodiments of such a computer program product may include one or more of the following features. The last possible block of the data stream is determined from a size of the data stream and a minimum block size for the blocks of the data stream. The data stream is defined by a cumulative stream size function, and a communication link for serving the data stream is defined by a cumulative link capacity function; and the block partition is determined with a reduced start-up delay for uninterrupted presentation of the data stream, given the cumulative stream size function and the cumulative link capacity function. The data stream is defined by a cumulative stream size function, and a target start-up delay is determined for serving the data stream; and the block partition is determined with a reduced transmission bandwidth that ensures uninterrupted presentation of the data stream, given the cumulative stream size function and the target start-up delay. A communication link for serving the data stream is defined by a cumulative link capacity function, and a target start-up delay is determined for serving the data stream; and the block partition is determined with a highest quality encoding of the data stream, from a set of possible encodings, that ensures uninterrupted presentation of the data stream, given the cumulative link capacity function and the target start-up delay.

An exemplary computer program product includes a processor-readable medium storing processor-readable instructions configured to cause a processor to: divide a data stream having a plurality of seek-points into a plurality of seek-blocks, each seek-point being a point in the data stream where the receiver can begin consuming the data stream within a predetermined start-up delay, wherein data on one side of a particular seek-point is decoding independent of data on another side of the particular seek-point; recursively define, for each seek-block of the plurality of seek-blocks, a respective effective start-up delay that is less than or equal to the predetermined start-up delay; determine, for each seek-block of the plurality of seek-blocks, a local block partition that ensures uninterrupted presentation of the respective seek-block with the respective effective start-up delay; and determine a global block partition for serving the data stream as the local block partitions of each seek-block of the plurality of seek-blocks in the data stream.

An exemplary apparatus configured to serve a data stream from a transmitter to a receiver includes: means for determining an underlying structure of the data stream; means for determining at least one objective, selected from a group of (1) reducing a start-up delay between when the receiver first starts receiving the data stream from the transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and means for transmitting the blocks of the data stream consistent with the at least one objective and the underlying structure.

Embodiments of such an apparatus may include the feature wherein the predetermined block constraints include a constraint that each block is of size greater than a given minimum block size and less than a given maximum block size.

An exemplary apparatus configured to determine a block partition for serving a data stream of bits from a transmitter to a receiver includes: means for defining a start position of a first block of the data stream as a first bit position in the data stream; means for iteratively determining for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block; means for defining an end-point of the last block of the data stream as the first bit position after the last bit position of the data stream; for each block, from a block before the last block to the first block of the data stream, means for determining an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block, and means for defining an end-point of the present block of the data stream as a bit position in the intersection; and means for determining the block partition as the end-points of each block in the data stream.

Embodiments of such an apparatus may include one or more of the following features. The last possible block of the data stream is determined from a size of the data stream and a minimum block size for the blocks of the data stream. The data stream is defined by a cumulative stream size function, and a communication link for serving the data stream is defined by a cumulative link capacity function; and the block partition is determined with a reduced start-up delay for uninterrupted presentation of the data stream, given the cumulative stream size function and the cumulative link capacity function. The data stream is defined by a cumulative stream size function, and a target start-up delay is determined for serving the data stream; and the block partition is determined with a reduced transmission bandwidth that ensures uninterrupted presentation of the data stream, given the cumulative stream size function and the target start-up delay. A communication link for serving the data stream is defined by a cumulative link capacity function, and a target start-up delay is determined for serving the data stream; and the block partition is determined with a highest quality encoding of the data stream, from a set of possible encodings, that ensures uninterrupted presentation of the data stream, given the cumulative link capacity function and the target start-up delay.

An exemplary apparatus configured to determine a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, includes: means for dividing the data stream into a plurality of seek-blocks, each seek-block defined by a respective local cumulative stream size function, wherein data on one side of a particular seek-point is decoding independent of data on another side of the particular seek-point; means for recursively defining, for each seek-block of the plurality of seek-blocks, a respective effective start-up delay that is less than or equal to the predetermined start-up delay; means for determining, for each seek-block of the plurality of seek-blocks, a local block partition that ensures uninterrupted presentation of the respective seek-block with the respective effective start-up delay; and means for determining the global block partition as the local block partitions of each seek-block of the plurality of seek-blocks in the data stream.

The capabilities provided by the block partitioning methods described herein include the following. The block partitioning methods described herein are computationally efficient to implement. For a given underlying sending order and consumption structure of the data to be streamed, the block partitioning methods described herein partition the data stream in such a way that the startup delay at a receiver receiving the blocked data stream is minimal. Furthermore, when the block partitioning methods are used in conjunction with block FEC codes that encode based on the block structure provided by the block partitioning methods described herein, the additional transmission bandwidth needed to provide a given level of protection against corruption of the stream is minimal. These benefits can be achieved even when a receiver receives the data stream, or requests the data stream, starting from arbitrary points within the data stream. These benefits can be achieved even when the data stream rate is variable over time.

### BRIEF DESCRIPTION OF THE DRAWINGS

FIG. 1 is a plot illustrating instantaneous and average presentation rate of a variable bit-rate (VBR) data stream.

FIG. 2 is a plot illustrating a typical trade-off curve between start-up delay and link capacity.

FIG. 3 is a plot illustrating an example of a cumulative stream size (CSS) function and a cumulative link capacity (CLC) function.

FIG. 4 is a plot illustrating an example of two blocked cumulative stream size (BCSS) functions for a single data stream.

FIG. 5 is a plot illustrating a geometric interpretation of reducing start-up delay for a fixed transmission bandwidth.

FIG. 6 is a plot illustrating a geometric interpretation of reducing transmission bandwidth for a fixed start-up delay.

FIG. 7 is a plot illustrating a geometric interpretation of increasing encoding quality of a data stream for a fixed start-up delay and a fixed transmission bandwidth.

FIG. 8 is a plot illustrating a geometric interpretation of a projection operation for determining a set of possible start positions for a block of the data stream.

FIG. 9 is a block flow diagram of a process of determining a block partition for serving a data stream.

FIG. 10 is a plot illustrating a geometric interpretation of impossible start positions for a block of the data stream.

FIG. 11 is a plot illustrating example effective start-up delays for multiple starting points in the data stream.

FIG. 12 is a block flow diagram of a process of determining a global block partition for serving a data stream having multiple starting points.

### DETAILED DESCRIPTION

Techniques described herein provide mechanisms for serving a data stream from a transmitter to a receiver, where transmission and reception of blocks of the data stream are consistent with an underlying structure of the data stream and one or more objectives determined for serving the data stream. The objectives for serving the data stream include reducing a start-up delay between when a receiver first starts receiving the data stream from the transmitter and when the receiver can start consumption of blocks of the data stream without interruption, according to the underlying structure; reducing a transmission bandwidth needed to send the data stream; and ensuring that the blocks of the data stream satisfy predetermined block constraints. Techniques are also described for determining a global block partition for serving a data stream, where the data stream has multiple possible seek-points where receivers can begin consuming the data stream within a maximum start-up delay. Other embodiments are within the scope of the disclosure and claims.

For real-time streaming applications, a transmitter serves a stream of data to be received at a receiver and consumed with a minimal amount of delay. One application is media streaming, where the media content is expected to be displayed or presented shortly after the streaming initiates. Although this disclosure includes examples from media streaming, the scope of the problems posed and the methods described herein are applicable beyond media applications and include any real-time streaming application where the stream of data is to be consumed, without interruption, while the data is being streamed. Nonetheless, for ease of reference, this disclosure includes terminology that generally applies to the media streaming application. Unless otherwise stated, the terms “consumption,” “presentation,” and “display” of a data stream are used interchangeably hereafter. Unless otherwise stated, for ease of reference, the size of data is expressed in units of bits, time is expressed in units of seconds, and rates are expressed in units of bits per second hereafter.

There are many environments in which the disclosed techniques can be used. One example is audio/streaming video to receivers over a broadcast/multicast network where data streams are available concurrently to many receivers. In this example, since a receiver may join or leave the stream at various points in time, it is important to reduce or minimize the start-up time between when a receiver joins the stream and when video is first available for consumption. For example, when a user first requests to start viewing a video stream, how long it takes the video to appear on the viewing screen of the receiver device after the user requests to view the stream is of critical importance to the quality of the service provided as perceived by the user, and the start-up time is a contributor to this time. As another example, when a user is viewing one stream and decides to “change channels” and view a different stream, how long it takes the first video to stop appearing on the viewing screen of the receiver device and for the second stream to start being displayed on the receiver device is of critical importance to the quality of the service provided as perceived by the user, and the start-up time is a contributor to this time. Another example is audio/video streaming over a unicast network where individual receivers request data streams, and may make requests to start consuming the stream at different points within the stream, e.g., in response to an end user sampling the video stream and jumping around to view different portions of the stream. The underlying packet transport protocol may be Moving Picture Experts Group-2 (MPEG-2) over User Datagram Protocol (UDP), Real-time Transport Protocol (RTP) over UDP, Hypertext Transfer Protocol/Transmission Control Protocol (HTTP/TCP), Datagram Congestion Control Protocol (DCCP) over UDP, or any of a variety of other transport protocols. In all of these cases, it is often important to protect the stream using FEC encoding to protect against corruption within the stream, e.g., to protect against packet loss when using UDP or RTP, or to protect against time loss when using HTTP as described in more detail in U.S. Provisional Application No. 61/244,767, entitled “Enhanced Block-Request Streaming System,” filed Sep. 22, 2009, which is hereby expressly incorporated by reference herein for all purposes.

The underlying data sending and consumption structure might be quite complicated, e.g., when the data stream is MPEG-2 video encoding, or H.263 or H.264 video encoding, and when the data stream is a combination of audio and video data. Furthermore, in these examples, the data sending order within the stream is often different from the data consumption structure. For example, a typical consumption order for a group of pictures (GOP) might be I-B-B-B-P-B-B-B-P, where here I refers to an I-frame or intra coded frame, P refers to a P-frame or a predicted encoded frame, and B refers to a B-frame or a bidirectional-predicted encoded frame. In this example, the P-frames depend on the I-frame, and the B-frames depend on the surrounding I-frame and P-frames. The sending order for this sequence might instead be I-P-B-B-B-P-B-B-B. That is, each P-frame in this example is sent before the three B-frames that depend on it, even though it is displayed after those three B-frames. Thus, the block partitioning methods need to be able to take into account various sending orders and consumption structures. There are a variety of different types of data streams to which the methods described herein can be applied, e.g., telemetry data streams, data streams used in command and control to operate remote vehicles or devices, and a variety of other types of data streams with structures too numerous to list herein. The block partitioning methods described herein apply to any number of different types of data streams with different sending and consumption structures. The original data does not even have to be necessarily thought of as a stream per se. For example, data for a high resolution map might be organized into a hierarchy of different resolutions and might be sent to an end user as a stream, organized in a sending order and a consumption order that allows quick display of the stream in low resolution as the first part of the data stream arrives and is consumed, and the display of the map is progressively refined and updated as additional portions of the data stream arrive and are consumed.

The environments wherein the block partitioning methods described herein might be used include real-time streaming, wherein it is important that the methods can be quickly applied to portions of the data stream as it is generated using as few computational resources as possible. The block partitioning methods can also be applied to on-demand streaming of already processed content, wherein the entire data stream might be available for processing before the data is streamed. It is also important for the on-demand streaming case that the block partitioning methods can be applied in a computationally efficient manner, as there may be limited computational resources available for applying the block partitioning methods, and there may be a volume of data streams to which the methods is applied.

Many different platforms can support streaming data from a source to a destination. The source can be a computer, a server, a client, a radio broadcast tower, a wireless transmitter, a network-enabled device, etc. The destination can be a computer, a server, a client, a radio receiver, a television, a wireless device, a telephone, a network-enabled device, etc. The source and destination can be separated by a channel (noiseless or lossy) that is one or more of wired, wireless or a channel in time (e.g., where the stream is stored as the source in storage and read as the destination from the device or media that forms the storage).

Other hardware, software, firmware, etc., can be used. These platforms can be programmed according to instructions embodying methods of operation described herein.

In streaming applications, the data may need to be partitioned into multiple contiguous blocks, where each block is decodable when enough data is received at the receiver to recover that block. For example, each block can be encoded using an FEC code to protect against packet loss or errors. As another example, each block can be encrypted for security.

There are often constraints on the blocks. For the example of FEC encoded blocks, shorter blocks offer less erasure protection and are more vulnerable to bursty packet loss or errors over the network. Thus, it is often preferable to encode FEC blocks of at least a specified minimum size. A particular choice of the positions of the block boundaries within a data stream is referred to as a “block partition” hereafter. A block partition that conforms to specified block constraints, such as a minimum block size, is referred to as a “feasible” partition.

Many applications use data streams that are of a variable bit-rate (VBR) nature. In the video streaming case, for example, high-action parts of a video require more data to encode and, consequently, higher bandwidth to transmit in real-time than stationary parts of the video. Using VBR encoding, for example, the amount of data encoded for each second of video can vary dramatically in different parts of the video. Often, VBR provides much more efficient encoding of video than constant bit-rate (CBR) encoding as measured by an amount of data needed to encode the entire video relative to the quality of the displayed video. Moreover, most modern video encoding techniques involve referencing methods, where, for encoding efficiency, some frames are described differentially relative to other frames. The frames that are referenced are much larger than the frames that are described differentially, contributing to the variations in the bit-rate at the frame-by-frame level.

The VBR nature of a data stream is with respect to the consumption of the data stream. That is, the VBR nature indicates the variability in the rate of data consumption at a receiver that ensures uninterrupted consumption. For example, the rate of consumption can be 5 million bits per second (Mbps) at some times, while at other times, the rate of consumption can be 1 Mbps. A data stream of a VBR nature can still be transmitted using a fixed amount of transmission bandwidth. For example, a transmitter can send a data stream of a VBR nature at a consistent bit-rate of 3 Mbps. Thus, at some times, the data stream arrives at a receiver at a rate that is slower than the rate at which the data stream is consumed, and at other times, the data stream arrives at the receiver at a rate that is faster than the rate at which the data stream is consumed.

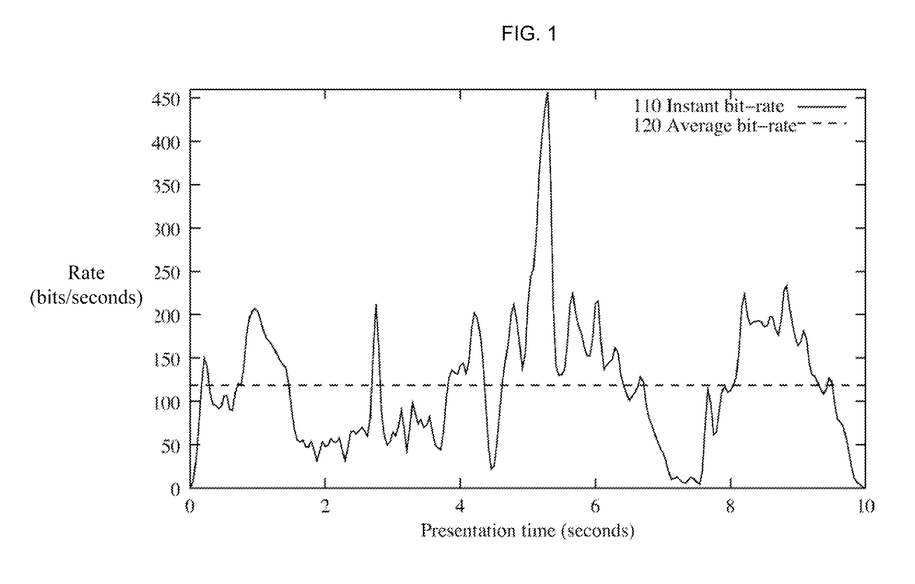

FIG. 1 illustrates the instantaneous consumption or presentation rate for an example VBR stream 110, where the presentation average bit-rate (ABR) 120 is depicted using a dashed horizontal line.

For a given data-stream, there is a trade-off between capacity of the link used for the streaming and the delay between when the transmitter begins transmission of the data stream and when the receiver can start the uninterrupted presentation of the stream (hereafter referred to as the “start-up delay”). If the receiver continues to receive the stream at or below the link capacity, the receiver can provide “uninterrupted presentation” of the stream if, by the time the receiver needs to consume, present or display any portion of the stream, the receiver will have received that portion. For the given data-stream, a combination of the link capacity and start-up delay that ensures uninterrupted presentation is referred to as an “achievable” pair.

If the link capacity is very large compared to the average bit-rate of the data stream, the receiver is able to receive a large portion of the data in a very short amount of time and will continue to receive at a higher rate than the consumption or presentation rate. In this scenario, very small start-up delays can be achieved. In another scenario, if the link capacity is very small compared to the average bit-rate of the stream, the receiver will not be able to start presentation until most of the data for the data stream has been received. If the receiver starts before this time, the receiver will need to interrupt the consumption or presentation in the middle of the data stream, and hence, the start-up delay may be large.

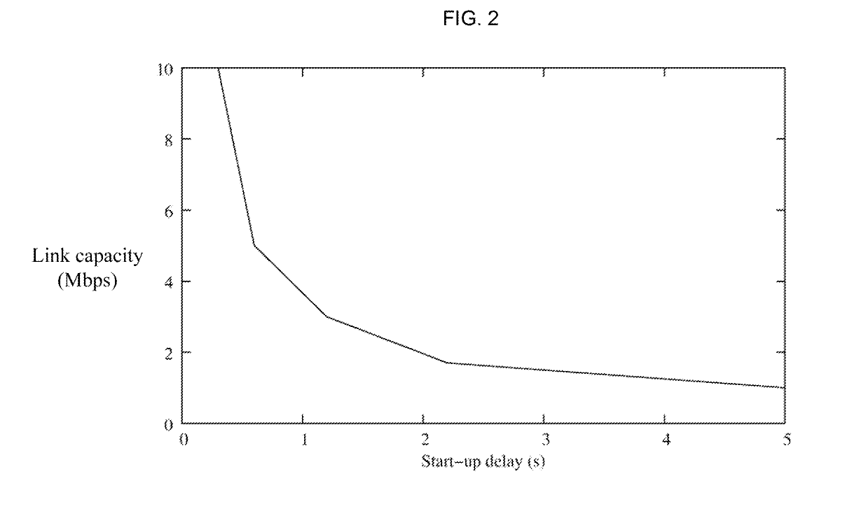

For a given data stream, the trade-off between the link-capacity and the start-up delay is a convex and decreasing function, as illustrated in FIG. 2, for nearly all practical applications.

For a given data stream, each feasible block partition corresponds to a particular capacity-versus-delay trade-off curve.

The apparatus, systems, and methods described herein determine combinations of link capacity and start-up delay that are achievable, and find feasible block partitions that ensure a particular achievable pair.

### Canonical Representation of a Data Stream

For ease in describing the apparatus, systems, and methods herein, the underlying structure of the presentation times of a data stream can be represented in a canonical form. A fixed data transmission order for the data stream is assumed. A “cumulative stream size” function L(t) (hereafter referred to as the CSS function) is defined, taking as its argument a presentation time t in the stream, and returning a size (in bits) of an initial portion of the data stream that needs to be received in order to present the stream up to and including time t. For ease of description, the presentation time is assumed to be zero when the first portion of the data stream is presented at a receiver, and thus L(t) represents the number of initial bits of the data stream that needs to be received and presented within time t after a receiver first starts presenting the data stream.

In some cases, presentation times at which presentations of bits occur can be essentially continual, whereas in other cases, presentation times at which presentations of bits occur can be at discrete points in time and can be evenly spaced through time. An example of presentation times evenly spaced in time is a video stream that is meant to be played out at precisely 24 frames per second, in which case bits are consumed at evenly spaced intervals of 1/24 of a second. Other frame rates are possible, and a rate of 24 frames per second is just an example.

The CSS function can be independent of a choice of any block partitioning method applied to the data stream and is a non-decreasing function of the presentation time t. That is, whenever t₁<t₂, L(t₂) initial bits of the data stream is enough to present up to t₂, which includes presentation up to t₁, and hence L(t₂)≧L(t₁). An alternative interpretation of the CSS function is through its inverse L⁻¹(s), which for each initial portion of the data stream, identified by the size s of that initial portion of the data stream, gives the amount of presentable duration of that initial portion of the data stream. This inverse function is then also a non-decreasing function.

As an example, consider a video stream encoded according to the Moving Picture Experts Group (MPEG) standard, with three types of frames: Intra (I) frames or key-frames, which do not reference any other frames; Predictive (P) frames, which can reference I- and P-frames presented in the past; and Bidirectional (B) frames, which can reference the I- and P-frames presented both in the past and in the future. A sample pattern of frames within a GoP can be as follows: I₁-B₂-P₃-B₄-P₅-B₆-P₇-B₈-P₉- . . . -Pₙ, where the index after each frame represents the presentation order of that frame. If, for example, the video is to be presented at a fixed frame rate, each index represents a fixed amount of time transpiring between each consecutive presentation time. As an example, if the frame rate is 24 frames per second, each frame is to be presented 1/24 of a second after the previous frame. Thus, the frame with index 1 has presentation time zero, and each subsequently indexed frame i has presentation time (i−1)/24 seconds in this example. While the MPEG example is given here, the subject matter of this disclosure is not so limited.

Typically, the transmission order of frames in a video data stream is in decoding order, as this minimizes the amount of buffer space needed to decode the video at a receiver without impacting how much of the data stream needs to be received to allow uninterrupted presentation. Continuing the example above, assuming that each B-frame only references the adjacent P-frames, the decoding order (and thus the transmission order) for the above pattern is: I₁-P₃-B₂-P₅-B₄-P₇-B₆-P₉-B₈ . . . .

Denoting by s(i) the size in bits of the frame with index i, the CSS function for this data stream example is:
L(0)=s(1);
L(1/24)=L(2/24)=L(0)+s(2)+s(3);
L(3/24)=L(4/24)=L(2/24)+s(4)+s(5);
L(5/24)=L(6/24)=L(4/24)+s(6)+s(7);
L(7/24)=L(8/24)=L(6/24)+s(8)+s(9), etc.

In the above example, the presentation times are discrete, and the CSS function L(t) can be defined on only those discrete points. However, for consistency with the continuous case described throughout this disclosure, L(t) is given as a function of a continuous time variable t, in accordance with the previous definition of L(t). Thus, if t₁ and t₂ are two consecutive discrete presentation times for a stream, then define L(t)=L(t₁) for all t₁≦t<t₂.

The CSS function generally captures all relevant presentation time information about the stream, including any variation in the instantaneous presentation rate of the stream, and possible presentation dependence between the samples in the pre-defined transmission order. Each data stream can be represented by a CSS function. Techniques for determining achievable pairs of link capacity and start-up delay can be developed in terms of arbitrary CSS functions and applied to a particular CSS function of a given data stream.

A similar function can be defined to represent the streaming link capacity. A “cumulative link capacity” function (hereafter referred to as a CLC function) is a non-decreasing function C(t), which has a value at a transmission time t that is a maximum amount of data that can be transmitted over the link up until transmission time t. That is, C(t) is the integral of the instantaneous link capacity from transmission time 0 up to time t. Similarly, C⁻¹(s) is defined as the time needed to transmit s bits of the data stream over the link.

For a link with a fixed capacity of r (for example, in units of bits-per-second), C(t) can be represented as a line with slope r, i.e., C(t)=r×t for transmission time t.

On a link with the CLC function C(t), uninterrupted presentation of a stream with the CSS function L(t) after a start-up delay d is possible if L(t)≦C(t+d) for all presentation times t in the stream. This is because at each transmission time (t+d), the receiver needs to have received at least L(t) bits of the initial portion of the data stream within the first t seconds after having started to present the data d seconds after the beginning of the start-up delay. However, this condition does not take into account additional constraints on the block partitioning methods described below, if blocking is used.

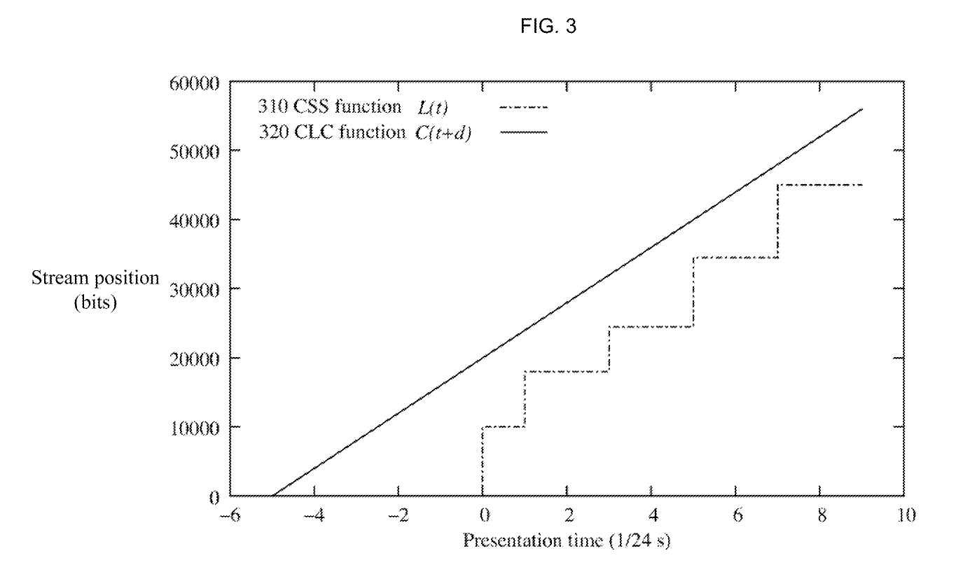

FIG. 3 displays the graphical interpretation of the above condition with d= 5/24 second and r=96000 bits-per-second, where the line corresponding to the CLC function C(t+d) 320 is always above the curve of the CSS function L(t) 310. The steps illustrate a particular data stream CSS corresponding to the example above, where s(1)=10,000 bits, s(2)=2,000 bits, s(3)=6,000 bits, s(4)=1,500 bits, s(5)=5,000 bits, s(6)=3,000 bits, s(7)=7,000 bits, s(8)=2,500 bits and s(9)=8,000 bits. Thus, the CSS function L(t) 310 for this data stream example is:
L(0)=s(1)=10,000 bits;
L(1/24)=L(2/24)=L(0)+s(2)+s(3)=18,000 bits;
L(3/24)=L(4/24)=L(2/24)+s(4)+s(5)=24,500 bits;
L(5/24)=L(6/24)=L(4/24)+s(6)+s(7)=34,500 bits;
L(7/24)=L(8/24)=L(6/24)+s(8)+s(9)=45,000 bits, etc.
   Canonical Representation of a Data Stream with Block Partitioning

When a data stream is partitioned into blocks, for example, because FEC or encryption is to be applied to the stream on a block-by-block basis, often a block of the data stream can only be presented or consumed when the entire block has been received. Thus, application of a block partitioning method to a data stream often results in a blocked data stream that has a “block cumulative stream size” function B(t) (hereafter referred to as the BCSS function). The BCSS function B(t) has as an argument a presentation time t in the stream and returns the size (in bits) of the initial portion of the data stream that needs to be received in order to present the stream up to and including time t. Portions of the data stream need to be presented on a block basis, i.e., data can be presented once the entire block that the data is part of has arrived.

The BCSS function B(t) is similar to the CSS function L(t), except that the block structure adds additional constraints on when data needs to be available for presentation. Thus, the BCSS function B(t) of a data stream always lies above the CSS function L(t) for the same data stream, regardless of the block structure that results from applying a block partitioning method to the data stream. It is preferable to have a BCSS function B(t) that is as little above the CSS function L(t) for a data stream as possible, in terms of the achievable start up delay and the link bandwidth needed to support uninterrupted presentation of the data stream. Using a block partitioning method that yields a BCSS function B(t) that is as close as possible to the CSS function L(t) and that satisfies the block constraints is one of the goals of the block partitioning techniques described hereafter.

Consider a data stream to which a block partitioning method has been applied to produce a block structure with BCSS function B(t). On a link with CLC function C(t), uninterrupted presentation of a stream after a start-up delay d is possible if B(t)≦C(t+d) for all presentation times t in the stream.

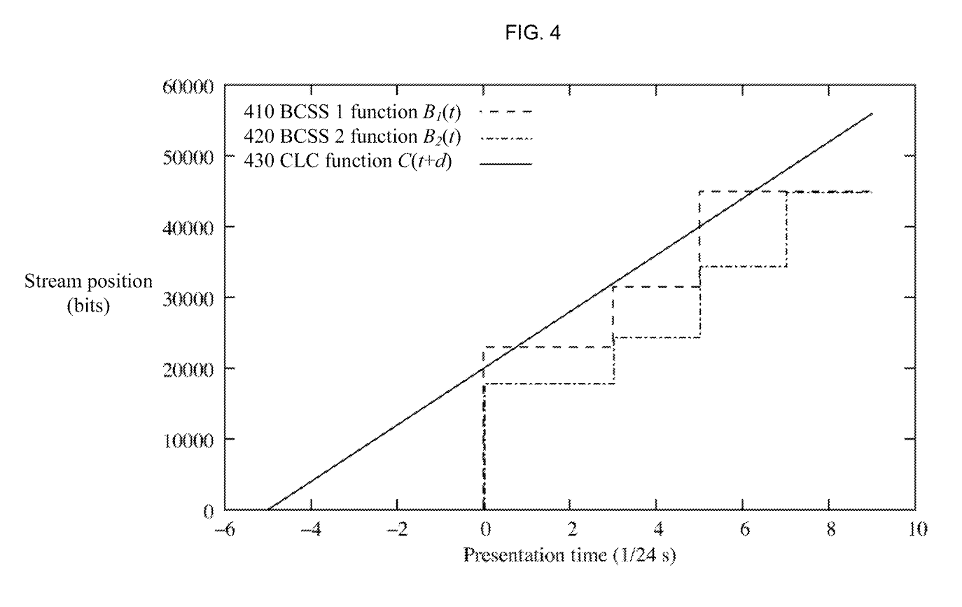

Two examples of BCSS functions, B₁(t) 410 and B₂(t) 420, for the same data stream are shown in FIG. 4. For the example discussed above, the BCSS function B₁(t) 410 corresponds to a first block partition {{I₁,P₃,B₂,P₅}, {B₄,P₇}, {B₆,P₉,B₈}}, whereas the BCSS function B₂(t) 420 corresponds to a second block partition {{I₁,P₃,B₂}, {P₅,B₄}, {P₇,B₆}, {P₉,B₈}}. The BCSS function B₂(t) 420 is preferable to the BCSS function B₁(t) 410 if both functions satisfy the block constraints, since the BCSS function B₂(t) 420 lies below the BCSS function B₁(t) 410. For example, the CLC function C(t+d) 430 can provide uninterrupted presentation for the BCSS function B₂(t) 420 but not for the BCSS function B₁(t) 410.

### Determining Achievable Pairs of Link Capacity and Start-Up Delay:

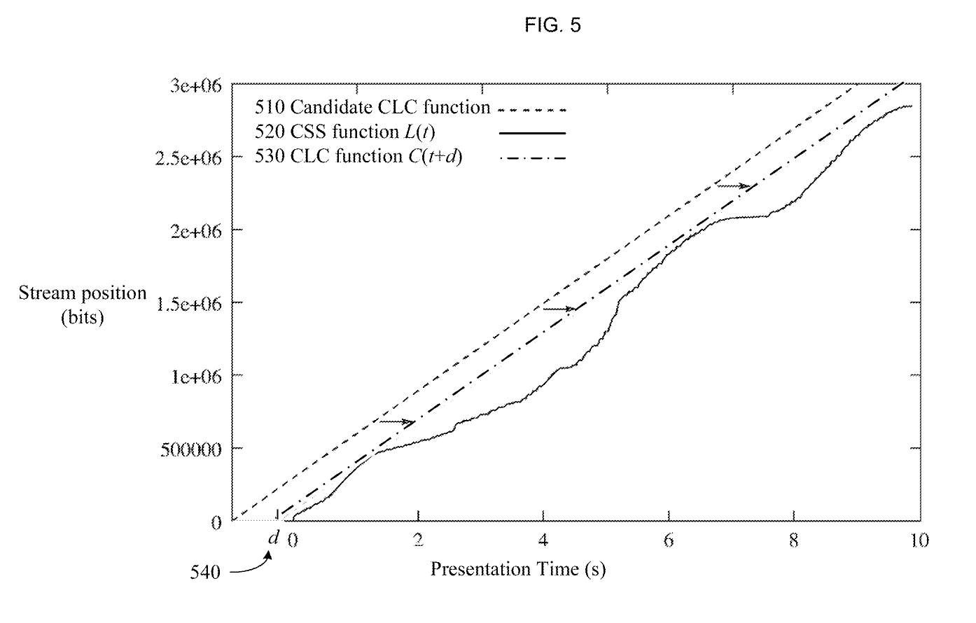

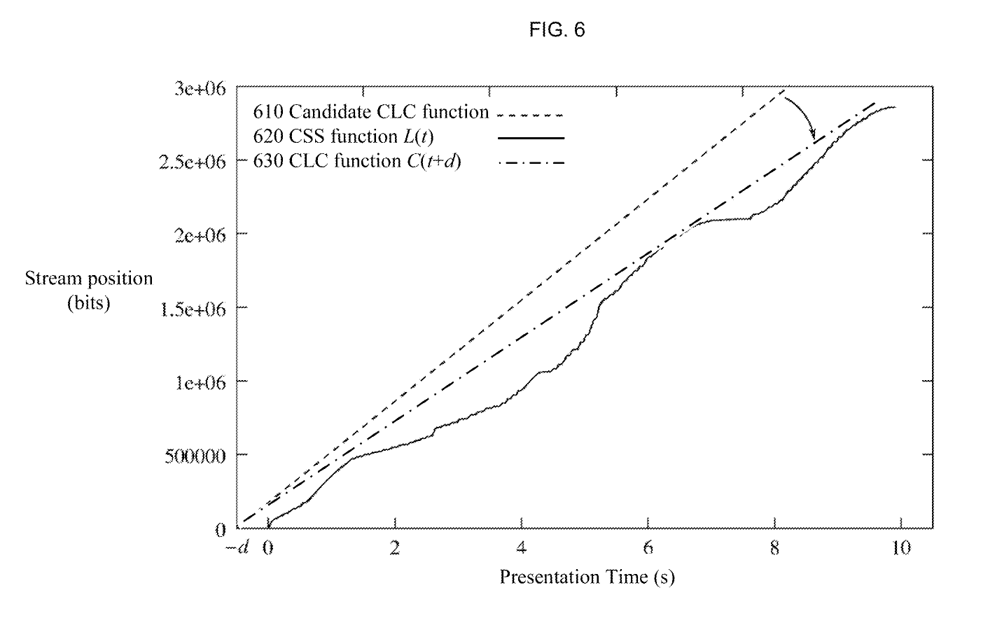

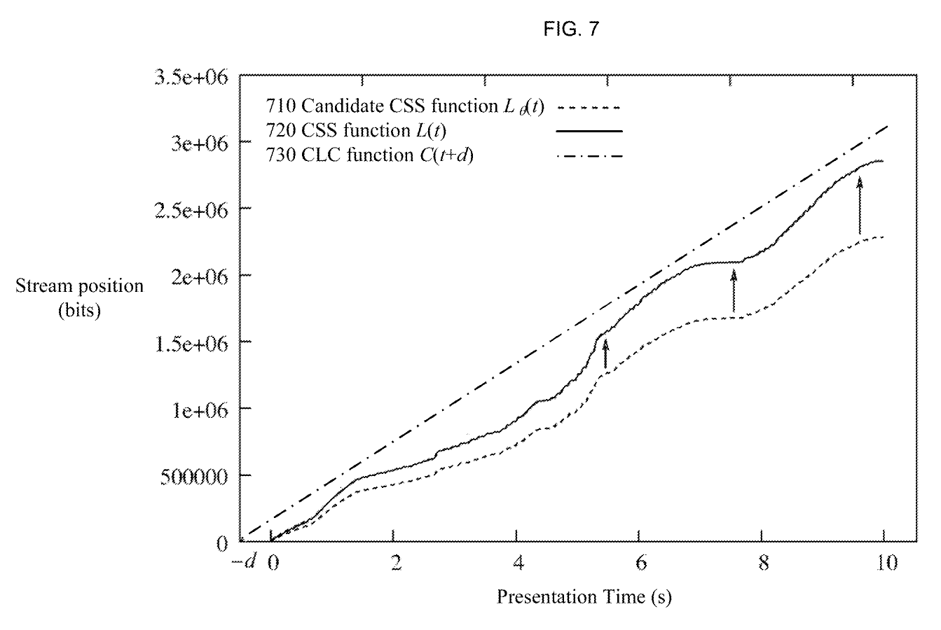

As discussed above, for a link with a constant capacity r, the CLC function C(t) can be represented as a line of slope r. For a constant capacity r, the problem of finding a preferable or an optimal trade-off between the capacity and the start-up delay has a simple geometric solution. Three variants are given of the concept adapted to three different design criteria:
1—For a link with a known capacity r, and for a fixed stream described by the CSS function L(t) 520, a reduced or minimum amount of start-up delay can be found. This is achieved by sliding a line of slope r (i.e., representing a candidate CLC function 510) on top of the curve for L(t) 520 until the line and the curve touch, as depicted in FIG. 5. The x-intercept of the slid line, representing the CLC function C(t+d) 530, gives the reduced achievable start-up delay d 540 for the link capacity r. The CLC function C(t+d) 530 is a lower bound for any feasible block partition.
2—For a target constraint on the start-up delay d, and for a fixed stream described by CSS function L(t) 620, a reduced or minimum link capacity needed to support uninterrupted presentation of the stream can be found. The x-intercept of a line representing the candidate CLC function 610 is fixed at (−d), and the line is rotated until the line touches the curve for L(t) 620, as depicted in FIG. 6. The slope of the rotated line, representing the CLC function C(t+d) 630, is the reduced achievable link capacity for the required start-up delay d. The CLC function C(t+d) 630 is a lower bound for any feasible block partition.
3—For a link with a known capacity r and a target constraint on the start-up delay d, a highest quality encoding of content that can be supported for uninterrupted presentation can be chosen. A candidate CSS function 710 for the encoding of the stream can be denoted as L_{θ}(t) with a quality parameter θ. A line of slope r and x-intercept −d, where the line represents the CLC function C(t+d) 730, is fixed. The quality parameter θ is increased, while ensuring that L_{θ}(t) 710 remains below the CLC function C(t+d) 730, as depicted in FIG. 7. The CSS function L(t) 720 can be defined after determining the highest achievable quality parameter θ. The CSS function L(t) 720 is an upper bound for any feasible block partition.
   Block Partitioning Methods that Satisfy Minimum Block Size Constraints

As discussed above, there may be practical reasons to have a minimum size constraint for each block. Let m denote this minimum block size. The techniques discussed above can be extended to provide an efficient method for determining achievable pairs of link capacity and start-up delay under a block size constraint and for determining a feasible block partition that achieves a given pair. These methods can be programmed, for example, into source devices and/or destination devices, or special purpose hardware can be used.

Assuming a start-up delay of d has been decided, for any transmission time t>d, the receiver needs to be able to present up to presentation time (t−d) into the stream. For s denoting a possible starting position of a block b, where s is the number of bits in the initial portion of the data stream up to and including the first bit of block b, a method is described that determines possible starting positions of a block that immediately follows block b that ensures that block b is feasible.

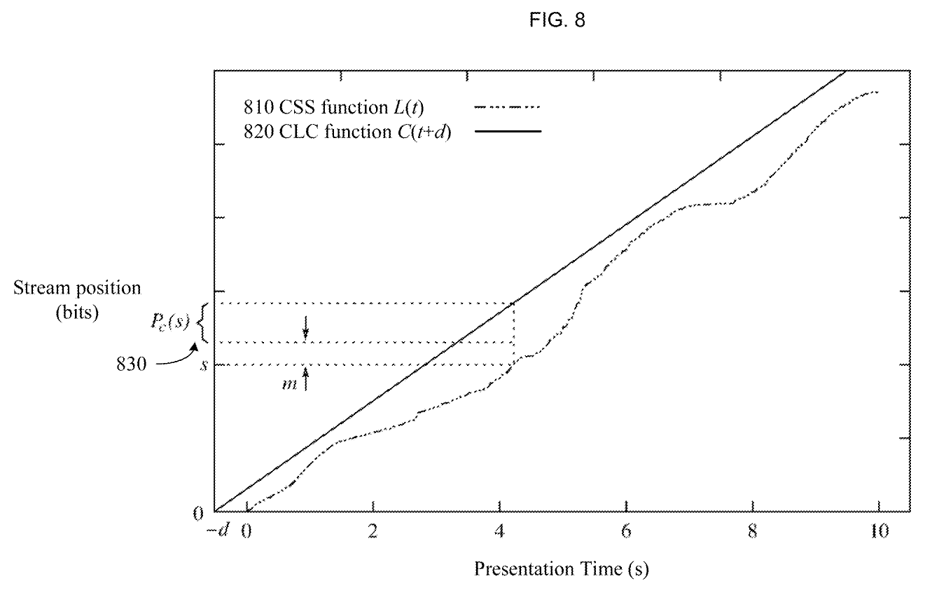

Referring to FIG. 8, for a data stream with the given CSS function L(t) 810, and a link with a CLC function C(t+d) 820, the C-projection of s, denoted by P_{C}(s) 830, is defined as the set of possible start positions for the block immediately following a block b that starts at position s that ensures that block b is feasible. Thus, P_{C}(s) is defined as:

P_{C}(s)=[s+m,C(L⁻¹(s)+d)]. (1)

In words, P_{C}(s) 830 is the (possibly empty) interval that starts with the position (s+m) bits into the stream (i.e., due to the minimum block size m) and extends up to the maximum amount of data that can be received by transmission time (L⁻¹(s)+d) from the start of transmission of the stream. In equation (1), d is the start-up time between the start of transmission and presentation time zero, and L⁻¹(s) is the presentation time for the first bit of block b. The set P_{C}(s) 830 is empty, and hence, s cannot be the start of any feasible blocks, if s+m>C(L⁻¹(s)+d). A geometric interpretation of the projection operation is depicted in FIG. 8.

Since, in general, the possible start positions of a block is more than a single position, the projection operation can be expanded to a more general case of subsets T of positions in the stream:

P_{C}(T)=∪_{sεT}P_{C}(s). (2)

An n-step projection is defined as the set of feasible start positions of a next block after n blocks have been formed starting from a given position s. For each integer n>0, the n-step projection P_{C}ⁿ(s) can be recursively defined as:

P_{C}ⁿ(s)=P_{C}(P_{C}ⁿ⁻¹(s)), (3)

where P_{C}⁰(s)={s}.

An inverse projection operator P_{C}⁻¹(s) is defined, which is the set of all feasible start positions of any block for which the subsequent block starts at position s:

P_{C}⁻¹(s)=[L(C⁻¹(s)−d),s−m]. (4)

The inverse projection of equation (4) can also be extended to the subsets T of positions in the stream:

P_{C}⁻¹(T)=∪_{sεT}P_{C}⁻¹(s). (5)

For the given constraints, uninterrupted presentation of the stream up to an end position e of the data stream is feasible if equation (6) below is met:

e+1εP_{C}ⁿ(1), (6)

for some positive n. In equation (6), n cannot exceed (1+e)/m, since each block has a minimum size of m.

To find a feasible block partition, the following forward-and-backward process can be used:

### Forward Loop:

For n=1 to (1+e)/m:
Calculate and store P_{C}ⁿ(1)=P_{C}(P_{C}ⁿ⁻¹(1))
If e+1εP_{C}ⁿ(1) (i.e., a feasible block partition with n blocks exists), then break and start the backward-loop.

End For

If the forward loop does not succeed in finding a feasible n, there are no feasible block partitions to achieve the constraints of the block parameters.

If the forward loop does succeed in finding a feasible n, the backward loop is executed:

### Backward Loop:

Set sₙ=e+1

For i=n−1 down to 1:
Calculate P_{C}⁻¹(sᵢ₊₁)∩P_{C}ⁱ(1). By construction, this is a non-empty set.
Pick any value from this set and assign to sᵢ.

End For

After completing the forward-and-backward process, s₁, s₂, . . . , sₙ define a feasible block partition as the end-points of each block.

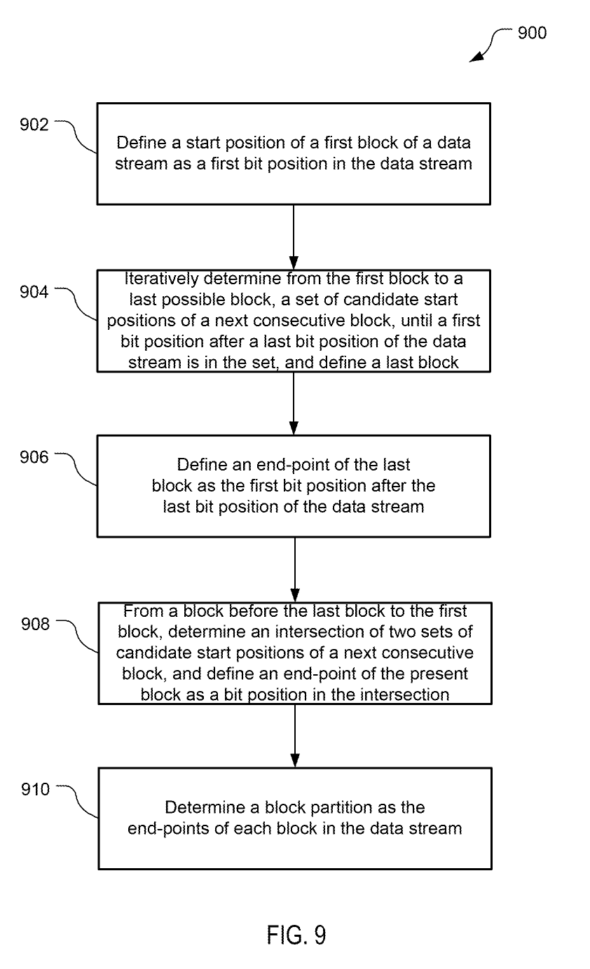

Referring to FIG. 9, a process 900 of determining a block partition for serving a data stream of bits from a transmitter to a receiver includes the stages shown. The process 900 describes the stages of the forward-and-backward process provided above for finding a feasible block partition. The process 900 is, however, exemplary only and not limiting. The process 900 can be altered, e.g., by having stages added, removed, or rearranged.

At stage 902, a processor (e.g., a processor on a source transmitter side of a communication link) defines a start position of a first block of the data stream as a first bit position in the data stream. Referring to the forward loop of the forward-and-backward process provided above, stage 902 defines the start position of the first block, block 1, as the first bit position in the data stream by setting P_{C}⁰(1)={1}.

At stage 904, the processor iteratively determines for each block, from the first block to a last possible block of the data stream, a first set of candidate start positions of a next consecutive block following a present block given that the first block starts at the first bit position of the data stream. The last possible block of the data stream can be determined from a size e of the data stream and a minimum block size m for the blocks of the data stream. Referring to the forward loop, stage 904 iteratively determines that P_{C}ⁿ(1)=P_{C}(P_{C}ⁿ⁻¹(1)) from the first block, block 1, to the last possible block, block floor[(1+e)/m]. The first sets of candidate start positions, P_{C}ⁿ(1), can be stored in memory (e.g., memory on a source transmitter side of a communication link).

The iterative determination of stage 904 continues until a first bit position after a last bit position e of the data stream is in the first set of candidate start positions determined for the next consecutive block. When this occurs, the iterations terminate, and the processor defines a last block of the data stream as the present block. Referring to the forward loop, stage 904 terminates the iterations when e+1εP_{C}ⁿ(1) for a present block, block n. The processor defines the last block of the data stream as block n.

At stage 906, the processor defines an end-point of the last block of the data stream as the first bit position after the last bit position of the data stream. Referring to the backward loop of the forward-and-backward process provided above, stage 906 defines sₙ=e+1.

At stage 908, for each block, from a block before the last block to the first block of the data stream, the processor determines an intersection of two sets of candidate start positions of a next consecutive block following a present block. The first set is the set of candidate start positions of a next consecutive block following a present block given that the first block starts at the first bit position of the data stream. The first sets for the blocks in the data stream were calculated at stage 904, referring to the forward loop. If the first sets were stored at stage 904, the first sets can be retrieved for determining the intersection in the present stage. The second set is the set of candidate start positions of the next consecutive block following the present block given that a block immediately following the next consecutive block starts at the end-point of the next consecutive block. Referring to the backward loop, for each block, from block i=n−1 down to block i=1 of the data stream, stage 908 first determines P_{C}⁻¹(sᵢ₊₁)∩P_{C}ⁱ(1).

Continuing stage 908, for the present block, the processor defines an end-point of the present block of the data stream as a bit position in the intersection. Referring to the backward loop, for the present block (i.e., block i), stage 908 then defines sᵢ as a bit position in P_{C}⁻¹(sᵢ₊₁)∩P_{C}ⁱ(1).

At stage 910, the processor determines the block partition as the end-points of each block in the data stream.

The above process takes at most (1+e)/m steps for the forward loop and (1+e)/m)−1 steps for the backward loop to complete. The process needs enough memory for storage of the forward projections P_{C}ⁿ(1).

Each P_{C}ⁿ(1) is an interval, or a collection of intervals, of presentation times. This fact allows the calculation and storage of the forward projection sets in a very efficient manner. Specifically, the projection of an interval [s1,s2] is simply:

P_{C}([s1,s2])=[s1+m,C(L⁻¹(s2)+d)]\{s:L⁻¹(s−m)<C⁻¹(s)−d}. (7)

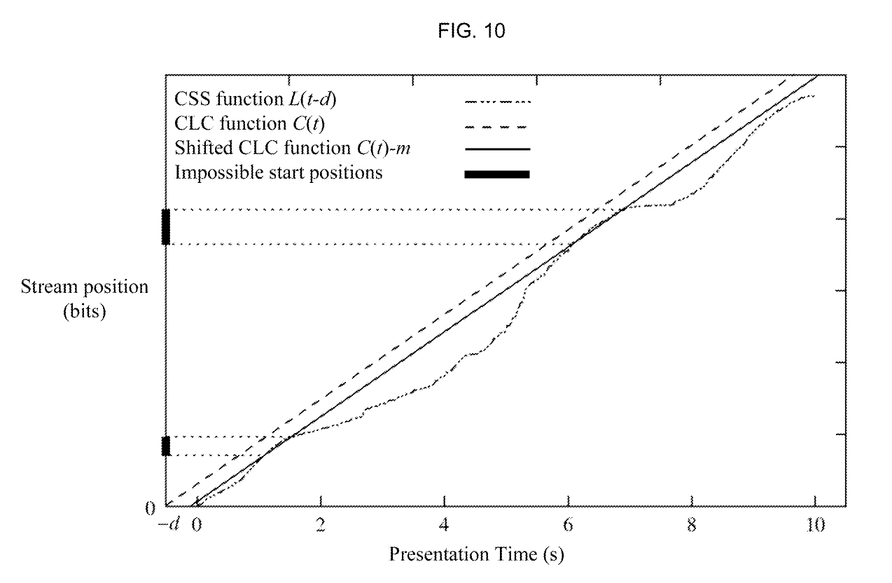

In equation (7), the interval on the right-hand side is defined by the lower-limits and the upper-limits imposed by the end-points of the original interval [s1, s2]. However, any stream position s for which the transmission completion time C⁻¹(s)−d exceeds the presentation constraint time L⁻¹(s−m) for a minimum block size m cannot be the start position of a block. The subtracted set in equation (7) is the set of these impossible start positions. A geometric interpretation of the set {s: L⁻¹(s−m)<C⁻¹(s)−d} of impossible start positions for blocks is depicted in FIG. 10.

As discussed above, the projection of an interval is a collection of intervals. The number of intervals in the collection is determined by the number of times the shifted curve of L(t)+m crosses the line representing the CLC function C(t+d), where each C⁻¹(s)−d corresponds to a presentation time t. In particular, for most smooth curves of CSS functions L(t), the shifted curve of L(t)+m and the line representing the CLC function C(t+d) do not cross more than once, and hence, the projection of an interval remains a single interval. Thus, each projection can be reduced to projecting the two end-points of an interval, which can speed up the calculations and reduce the memory storage needed.

### Determining Feasible Block Partition

For a given CSS function L(t) and a fixed transmission bandwidth r, if a block partition with a BCSS function B(t) is achievable with a start-up delay d1, the block partition remains achievable for any larger start-up delay d2, since the area between the curve of L(t) and the line representing C(t+d) strictly increases with increasing d. Similarly, for a fixed start-up delay d, if a block partition with a BCSS function B(t) is achievable on a link with capacity r1, then the block partition is also achievable on a link with larger capacity r2, since the area between the curve of L(t) and the line representing C(t+d)=r×(t+d) also strictly increases with increasing r.

If, in addition, the feasibility constraints imposed on the block partitioning method satisfy a similar “monotonicity” condition with respect to the optimization parameters, —i.e., that whenever a block partition is feasible for values x1 and x2 of an optimization parameter, the block partition is also feasible for all the values in between—then the methods described above can be combined with a binary search to efficiently determine a best or optimal feasible combination of the start-up delay, transmission bandwidth, and the encoding quality.

An example of a monotonic feasibility constraint is a constraint on a minimum and/or a maximum size of blocks. An example of a non-monotonic constraint is a limitation on a minimum transmission duration of the blocks, since feasibility then depends on the transmission bandwidth, which is an optimization parameter. In that case, increasing the bandwidth has the potential of decreasing the transmission duration of some blocks to below the feasibility constraint.

The techniques discussed below assume that the feasibility constraints are monotonic in the above sense. Three scenarios of interest are described for determining block partitioning methods.

In the first scenario, given a stream with a CSS function L(t) and a link with a CLC function C(t), a feasible block partitioning method is determined with a reduced or minimum start-up delay for uninterrupted presentation of the stream.

A minimum value d0 and a maximum value d1 are denoted for the start-up delay, where d1 is assumed achievable. For example, d0 can be set to 0, or d0 can be set to the unconstrained lower bound for the start-up delay, the determination of which is described above with reference to FIG. 5. The maximum value d1 can be set to the largest acceptable value for the start-up delay. A binary search can be performed as follows:

Do
Set d=(d0+d1)/2.
Run the forward loop of the forward-and-backward process for determining unconstrained feasible block partitions, with start-up delay d.
If d is feasible,
   then set d1=d;
   else set d0=d.

While d is not feasible or (d1−d0)>ε, for a small tolerance ε.
d is within ε of the best or optimal feasible start-up delay. Run the backward loop of the forward-and-backward process to find a feasible block partitioning.

In the second scenario, given the start-up delay d, a feasible block partitioning method is determined with a reduced or minimum transmission bandwidth that ensures uninterrupted presentation of the data stream as represented by the CSS function L(t). A reduced or minimum link capacity translates to a reduced or minimum transmission bandwidth.

A minimum value r0 and a maximum value r1 is denoted for the transmission bandwidth. For example, r0 can be set to 0, or r0 can be set to the unconstrained lower bound for the link capacity, the determination of which is described above with reference to FIG. 6. The maximum value r1 can be set to the largest acceptable value for the capacity of the link. A binary search similar to the binary search of the first scenario is performed to find a rate r within ε of the best or optimal feasible transmission bandwidth and a corresponding feasible block partition.

In the third scenario, given a link with a CLC function C(t) and a fixed start-up delay d, a feasible block partitioning method is determined with the highest quality encoding of a data stream that can be presented without interruption.

As discussed above in reference to FIG. 7, the quality of the encoding is parameterized with a variable θεΘ, where Θ is the set of all possible encodings of the data stream. L_{θ}(t) denotes the CSS function of the encoding with quality θ.

In order to use a binary search in this scenario, in addition to the monotonicity of the feasibility constraints, the encodings of the stream are also assumed to be monotonic, i.e., whenever θ1<θ2 for θ2 having higher quality, L_{θ1}(t)≦L_{θ2}(t) for all values of presentation time t. A binary search similar to the binary searches of the first and second scenarios is performed to find the highest quality encoding. At each iteration, the binary search tests the achievability of encoding with the median quality variable θ in the ordered subset of candidates. Assuming a finite set Θ, the binary search terminates after n=log(|Θ|) iterations.

If either one of the monotonicity conditions discussed above is not satisfied, the forward loop of the forward-and-backward process for determining unconstrained feasible block partitions will need to be run on O(|Θ|) of the elements of Θ to find the highest quality encoding.

Block Partitioning Methods for a Data Stream with Multiple Starting Points:

A streaming application may allow a receiver to request and consume data at multiple different starting points within a stream (hereafter referred to as the “seek-points”). For example, in a video streaming application, it is preferable for a user to be able to watch a video from the middle of the stream, e.g., to skip over parts already watched, or to rewind to review missed parts. Bandwidth and start-up delay constraints should be observed for starting the stream at any one of the predefined seek-points.

Typically, block partitioning of a data stream cannot change on the fly and in response to users' requests for different starting points. Preferably, a single best or optimal block partitioning method would provide simultaneous guarantees on the bandwidth and start-up delay constraints for all possible seek-points.

One possible solution is to use the techniques discussed above to find a block partition on the entire stream that optimizes the bandwidth and delay constraints for starting from the beginning of the stream, and then recalculate the achievable bandwidth-versus-start-up delay pairs for all other possible seek-points. This information can be communicated to the receiver as additional metadata about the stream, to be used for each desired starting point.

However, this block partitioning solution would only be optimal for streaming from the beginning. It is likely that, for the same transmission bandwidth, the receiver would need completely different start-up delay times to start from different seek-points, which may be an undesirable condition.

Another solution which addresses the above concern would be to determine a best or optimal block partitioning method that guarantees a given maximum start-up delay with the given transmission bandwidth, simultaneously for all seek-points. An efficient method to determine this best or optimal block partitioning method is described.

Let t₀<t₁< . . . <tₙ be all the possible seek-points (in presentation time units) within a data-stream. For simplicity, the decoding dependence in the data stream is assumed broken across each seek-point. That is, for each seek-point tᵢ, there is a position g(tᵢ) in the data stream where the following two conditions are true: a receiver having received the stream up to that position g(tᵢ) is able to present the stream up to presentation time tᵢ; and a receiver that starts receiving the stream from the position g(tᵢ) onwards is able to present the stream from presentation time tᵢ onwards. In the video coding context, this condition is referred to as a “closed GoP” structure, where there are no references between the frames across the seek-points. The portion of the data stream starting from each g(tᵢ), inclusive, to the subsequent g(tᵢ₊₁), exclusive, is denoted as a “seek-block”.

A new source block (i.e., a block of the data stream) starts at the beginning of each seek-block. If this is not the case, to start at seek-point tᵢ, the receiver would need to receive and decode data that is not needed for presentation from time tᵢ onwards, likely increasing the start-up delay. Assuming that a new source block starts at the beginning of each seek-block, the global block partitioning can be subdivided into smaller partitionings over individual seek-blocks.

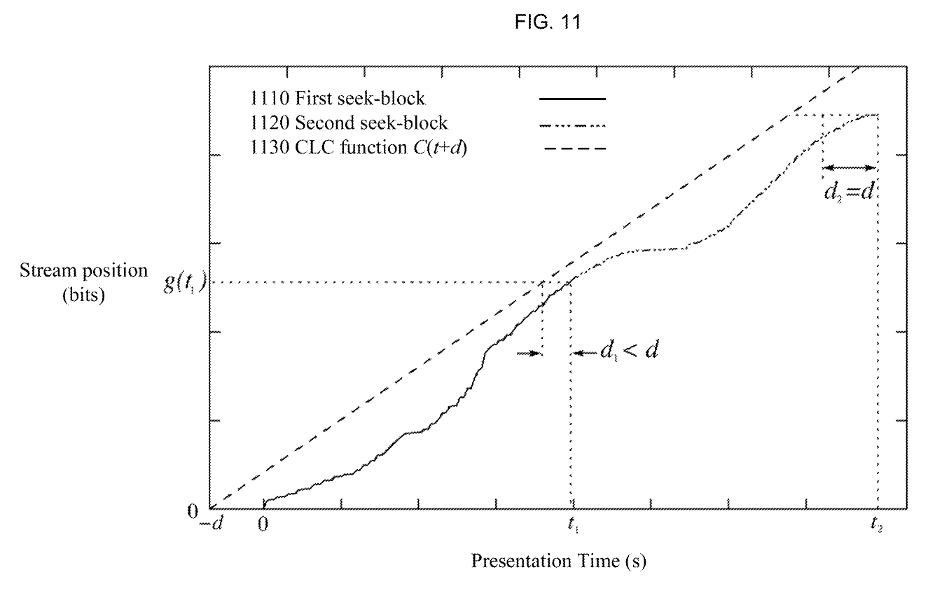

In an example, a particular block partition is determined, where starting at each seek-point and streaming over a link with a fixed capacity r, the stream can be presented without interruption after a start-up delay of d. The application of the block partitioning to each seek-block needs to satisfy the same condition (i.e., uninterrupted presentation after the start-up delay d) independently of other seek-blocks. However, the transmission of some seek-blocks may take more time than their corresponding presentation duration. In that case, for continuous presentation, the transmission of the next seek-block will start at a later time relative to its starting presentation time than the time the transmission would have started had the receiver started streaming from that seek-point. In other words, the next seek-block will have to be presentable with an effective start-up delay that is strictly less than the original delay d. This situation is illustrated with the first seek-block 1110 in FIG. 11. The delay dᵢ can be viewed as an excess delay from the seek-block i that can be used as a head start delay for the next seek-block i+1. The modified block partitioning technique below addresses this condition.

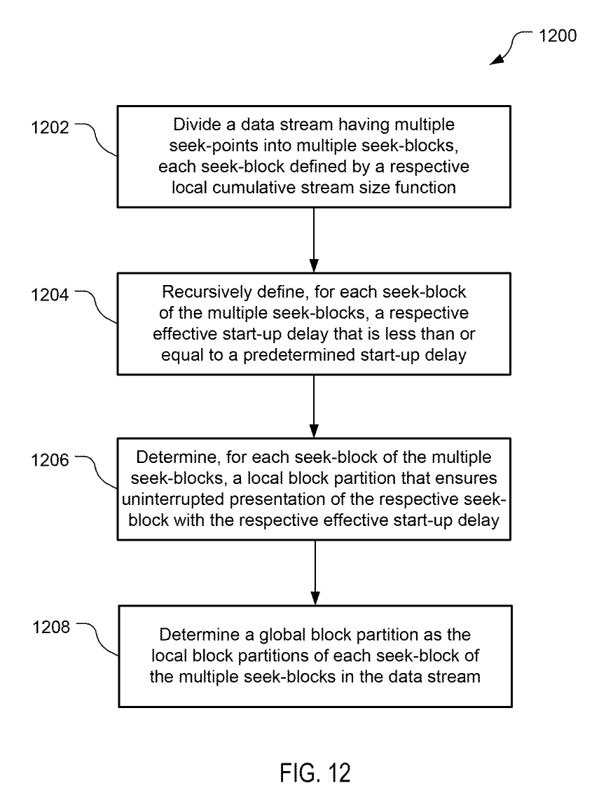

Referring to FIG. 12, with further reference to FIG. 11, a process 1200 of determining a global block partition for serving a data stream having multiple seek-points includes the stages shown. The data stream is defined by a global CSS function L(t). Each seek-point is a point in the data stream where the receiver can begin consuming the data stream within a predetermined start-up delay d. The process 1200 is, however, exemplary only and not limiting. The process 1200 can be altered, e.g., by having stages added, removed, or rearranged.

At stage 1202, a processor (e.g., a processor on a source transmitter side of a communication link) divides the data stream into multiple seek-blocks, where each seek-block is defined by a respective local CSS function. The data stream, defined by the original, global CSS function L(t), is subdivided into seek-blocks. For each seek-block i=1, 2, . . . , n, the local CSS function Lᵢ(t)=L(t+tᵢ₋₁)−L(tᵢ₋₁) is defined for presentation times 0≦t≦pᵢ, where pᵢ=tᵢ−tᵢ₋₁ is a presentation duration of the seek-block i.

Each end-point of a seek-block can be a seek-point, a start-point of the data stream, or an end-point of the data stream. Data on one side of a particular seek-point is decoding independent of data on another side of the particular seek-point.

At stage 1204, the processor recursively defines, for each seek-block of the multiple seek-blocks, a respective effective start-up delay that is less than or equal to the predetermined start-up delay d. The effective start-up delay for each seek-block is recursively defined as follows:

dᵢ=min(d,pᵢ+dᵢ₋₁−C⁻¹(Lᵢ(pᵢ))), (8)

for i=1, 2, . . . , n and with d₀=d. In equation (8), pᵢ+dᵢ₋₁ denotes the time from the start of transmission of the seek-block i to the start of presentation of the seek-block i+1. The subtracted term C⁻¹(Lᵢ(pᵢ)) is the transmission duration of the seek-block i. The difference, pᵢ+dᵢ₋₁−C⁻¹(Lᵢ(pᵢ)), is the accumulated excess delay that can potentially be used as the head start delay for the next seek-block i+1. However, because each seek-block needs to be independently presentable with a maximum start-up delay of d, the effective start-up delay is determined as the minimum of d and the accumulated excess delay.

FIG. 11 illustrates an example of two scenarios, where the effective start-up delay is less than or equal to the original target delay d.

In words, the effective start-up delay for each seek-block is at most d (i.e., for the case when streaming starts at that seek-block), but the effective start-up delay will be less than d if the transmission of previous seek-blocks extends beyond the corresponding presentation duration of the previous seek-blocks.

A feasible global block partitioning which simultaneously guarantees uninterrupted presentation starting from any of the seek-points, with a start-up delay of at most d, exists if, for each seek-block i, a feasible local block partitioning for uninterrupted presentation with a start-up delay of dᵢ exists.

At stage 1206 of FIG. 12, the processor determines, for each seek-block of the multiple seek-blocks, a local block partition that ensures uninterrupted presentation of the respective seek-block with the respective effective start-up delay.

The techniques described above for determining a feasible global block partitioning can be used on each seek-block i with its local CSS function Lᵢ(t) and the modified effective start-up delay dᵢ, calculated as described above from the original constraint d on the start-up delay.

At stage 1208, the processor determines the global block partition as the respective local block partitions of each seek-block of the multiple seek-blocks in the data stream.

Note that the above technique for determining a feasible global block partitioning is performed effectively with one forward loop and one backward loop over the entire data stream; in this sense, the additional constraints imposed by the multiple seek-points do not affect the efficiency of the technique.

### Considerations Regarding the Description

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The blocks of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software executed by a processor, firmware, or any combination thereof. If implemented in software executed by a processor, the functions may be stored on or transmitted over as one or more instructions or code on a computer-readable medium. Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of computer-readable media.

The previous description is provided to enable any person skilled in the art to make and/or use the apparatus, systems, and methods described. Various modifications to the disclosure will be readily apparent to those skilled in the art, and the generic principles defined herein may be applied to other variations without departing from the spirit or scope of the disclosure. Thus, the disclosure is not to be limited to the examples and designs described herein but is to be accorded the widest scope consistent with the principles and novel features disclosed herein.

What is claimed is:

1. A method for serving a data stream from a transmitter to a receiver, comprising:
determining an underlying structure of the data stream;
determining at least one objective, selected from a group of (1) reducing a start-up delay between when the receiver first starts receiving the data stream from the transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and
transmitting the blocks of the data stream consistent with the at least one objective and the underlying structure.

2. The method of claim 1, wherein the predetermined block constraints include a constraint that each block is of size greater than a given minimum block size and less than a given maximum block size.

3. A method for determining a block partition for serving a data stream of bits from a transmitter to a receiver, comprising:
defining a start position of a first block of the data stream as a first bit position in the data stream;
iteratively determining for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block;
defining an end-point of the last block of the data stream as the first bit position after the last bit position of the data stream;
for each block, from a block before the last block to the first block of the data stream,
determining an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block; and
defining an end-point of the present block of the data stream as a bit position in the intersection; and
determining the block partition as the end-points of each block in the data stream.

4. The method of claim 3, wherein the last possible block of the data stream is determined from a size of the data stream and a minimum block size for the blocks of the data stream.

5. The method of claim 3, wherein
the data stream is defined by a cumulative stream size function, and a communication link for serving the data stream is defined by a cumulative link capacity function; and
the block partition is determined with a reduced start-up delay for uninterrupted presentation of the data stream, given the cumulative stream size function and the cumulative link capacity function.

6. The method of claim 3, wherein
the data stream is defined by a cumulative stream size function, and a target start-up delay is determined for serving the data stream; and
the block partition is determined with a reduced transmission bandwidth that ensures uninterrupted presentation of the data stream, given the cumulative stream size function and the target start-up delay.

7. The method of claim 3, wherein
a communication link for serving the data stream is defined by a cumulative link capacity function, and a target start-up delay is determined for serving the data stream; and
the block partition is determined with a highest quality encoding of the data stream, from a set of possible encodings, that ensures uninterrupted presentation of the data stream, given the cumulative link capacity function and the target start-up delay.

8. A method for determining a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, comprising:
dividing the data stream into a plurality of seek-blocks, each seek-block defined by a respective local cumulative stream size function, wherein data on one side of a particular seek-point is decoding independent of data on another side of the particular seek-point;
recursively defining, for each seek-block of the plurality of seek-blocks, a respective effective start-up delay that is less than or equal to the predetermined start-up delay;
determining, for each seek-block of the plurality of seek-blocks, a local block partition that ensures uninterrupted presentation of the respective seek-block with the respective effective start-up delay; and
determining the global block partition as the local block partitions of each seek-block of the plurality of seek-blocks in the data stream.

9. A server for serving a data stream, the server comprising:
a processor configured to determine an underlying structure of the data stream, and to determine at least one objective, selected from a group of (1) reducing a start-up delay between when a receiver first starts receiving the data stream from a transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and
a transmitter coupled to the processor and configured to transmit the blocks of the data stream consistent with the at least one objective and the underlying structure.

10. The server of claim 9, wherein the predetermined block constraints include a constraint that each block is of size greater than a given minimum block size and less than a given maximum block size.

11. The server of claim 9, wherein the data stream comprises video content, and the blocks of the data stream are transmitted using User Datagram Protocol.

12. A server for determining a block partition for serving a data stream of bits from a transmitter to a receiver, the server comprising:
a processor configured to define a start position of a first block of the data stream; determine a last block of the data stream by iteratively determining for each block, from the first block to a last possible block of the data stream, a first set of candidate start positions of a next consecutive block following a present block; define an end-point of the last block of the data stream; iteratively defining, for each block, from a block before the last block to the first block of the data stream, an end-point of a present block of the data stream as a bit position in an intersection of the first set and a second set of candidate start positions of a next consecutive block following the present block; and determine the block partition as the end-points of each block in the data stream.

13. The server of claim 12 further comprising a memory coupled to the processor for storing the first set of candidate start positions.

14. The server of claim 12 further comprising a storage device coupled to the processor for storing content to be served as the data stream.

15. The server of claim 12 wherein
the data stream is defined by a cumulative stream size function, and a communication link for serving the data stream is defined by a cumulative link capacity function; and
the block partition is determined with a reduced start-up delay for uninterrupted presentation of the data stream, given the cumulative stream size function and the cumulative link capacity function.

16. The server of claim 12 wherein
the data stream is defined by a cumulative stream size function, and a target start-up delay is determined for serving the data stream; and
the block partition is determined with a reduced transmission bandwidth that ensures uninterrupted presentation of the data stream, given the cumulative stream size function and the target start-up delay.

17. The server of claim 12 wherein
a communication link for serving the data stream is defined by a cumulative link capacity function, and a target start-up delay is determined for serving the data stream; and
the block partition is determined with a highest quality encoding of the data stream, from a set of possible encodings, that ensures uninterrupted presentation of the data stream, given the cumulative link capacity function and the target start-up delay.

18. A server for determining a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, the apparatus comprising:
a processor configured to divide the data stream into a plurality of seek-blocks, each seek-block defined by a respective local cumulative stream size function, wherein data on one side of a particular seek-point is decoding independent of data on another side of the particular seek-point; recursively define, for each seek-block of the plurality of seek-blocks, a respective effective start-up delay that is less than or equal to the predetermined start-up delay; determine, for each seek-block of the plurality of seek-blocks, a local block partition that ensures uninterrupted presentation of the respective seek-block with the respective effective start-up delay; and determine the global block partition as the local block partitions of each seek-block of the plurality of seek-blocks in the data stream.

19. A computer program product comprising:
a processor-readable medium storing processor-readable instructions configured to cause a processor to:
determine an underlying structure of a data stream;
determine at least one objective, selected from a group of (1) reducing a start-up delay between when a receiver first starts receiving the data stream from a transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and
determine a block partition for serving the data stream from the transmitter to the receiver, wherein the block partition ensures that transmitting and receiving the blocks of the data stream is consistent with the at least one objective and the underlying structure.

20. The computer program product of claim 19, wherein the predetermined block constraints include a constraint that each block is of size greater than a given minimum block size and less than a given maximum block size.

21. A computer program product comprising:
a processor-readable medium storing processor-readable instructions configured to cause a processor to:
define a start position of a first block of a data stream as a first bit position in the data stream;
iteratively determine for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block;
define an end-point of the last block of the data stream as the first bit position after the last bit position of the data stream;
for each block, from a block before the last block to the first block of the data stream,
determine an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block; and
define an end-point of the present block of the data stream as a bit position in the intersection; and
determine the block partition as the end-points of each block in the data stream.

22. The computer program product of claim 21, wherein the last possible block of the data stream is determined from a size of the data stream and a minimum block size for the blocks of the data stream.

23. The computer program product of claim 21, wherein
the data stream is defined by a cumulative stream size function, and a communication link for serving the data stream is defined by a cumulative link capacity function; and
the block partition is determined with a reduced start-up delay for uninterrupted presentation of the data stream, given the cumulative stream size function and the cumulative link capacity function.

24. The computer program product of claim 21, wherein
the data stream is defined by a cumulative stream size function, and a target start-up delay is determined for serving the data stream; and
the block partition is determined with a reduced transmission bandwidth that ensures uninterrupted presentation of the data stream, given the cumulative stream size function and the target start-up delay.

25. The computer program product of claim 21, wherein
a communication link for serving the data stream is defined by a cumulative link capacity function, and a target start-up delay is determined for serving the data stream; and
the block partition is determined with a highest quality encoding of the data stream, from a set of possible encodings, that ensures uninterrupted presentation of the data stream, given the cumulative link capacity function and the target start-up delay.

26. A computer program product comprising:
a processor-readable medium storing processor-readable instructions configured to cause a processor to:
divide a data stream having a plurality of seek-points into a plurality of seek-blocks, each seek-point being a point in the data stream where the receiver can begin consuming the data stream within a predetermined start-up delay, wherein data on one side of a particular seek-point is decoding independent of data on another side of the particular seek-point;
recursively define, for each seek-block of the plurality of seek-blocks, a respective effective start-up delay that is less than or equal to the predetermined start-up delay;
determine, for each seek-block of the plurality of seek-blocks, a local block partition that ensures uninterrupted presentation of the respective seek-block with the respective effective start-up delay; and
determine a global block partition for serving the data stream as the local block partitions of each seek-block of the plurality of seek-blocks in the data stream.

27. An apparatus configured to serve a data stream from a transmitter to a receiver, the apparatus comprising:
means for determining an underlying structure of the data stream;
means for determining at least one objective, selected from a group of (1) reducing a start-up delay between when the receiver first starts receiving the data stream from the transmitter and when the receiver can start consumption of blocks of the data stream without interruption, according to the underlying structure, (2) reducing a transmission bandwidth needed to send the data stream, and (3) ensuring that the blocks of the data stream satisfy predetermined block constraints; and
means for transmitting the blocks of the data stream consistent with the at least one objective and the underlying structure.

28. The apparatus of claim 27, wherein the predetermined block constraints include a constraint that each block is of size greater than a given minimum block size and less than a given maximum block size.

29. An apparatus configured to determine a block partition for serving a data stream of bits from a transmitter to a receiver, the apparatus comprising:
means for defining a start position of a first block of the data stream as a first bit position in the data stream;
means for iteratively determining for each block, from the first block to a last possible block of the data stream, a first set of candidate start positions of a next consecutive block following a present block given that the first block starts at the first bit position of the data stream, until a first bit position after a last bit position of the data stream is in the first set of candidate start positions determined for the next consecutive block, and define a last block of the data stream as the present block;
means for defining an end-point of the last block of the data stream as the first bit position after the last bit position of the data stream;
for each block, from a block before the last block to the first block of the data stream,
means for determining an intersection of (1) the first set of candidate start positions of a next consecutive block following a present block given that the first block starts at the first bit position of the data stream; and (2) a second set of candidate start positions of the next consecutive block following the present block given that a block immediately following the next consecutive block starts at the end-point of the next consecutive block; and
means for defining an end-point of the present block of the data stream as a bit position in the intersection; and
means for determining the block partition as the end-points of each block in the data stream.

30. The apparatus of claim 29, wherein the last possible block of the data stream is determined from a size of the data stream and a minimum block size for the blocks of the data stream.

31. The apparatus of claim 29, wherein
the data stream is defined by a cumulative stream size function, and a communication link for serving the data stream is defined by a cumulative link capacity function; and
the block partition is determined with a reduced start-up delay for uninterrupted presentation of the data stream, given the cumulative stream size function and the cumulative link capacity function.

32. The apparatus of claim 29, wherein
the data stream is defined by a cumulative stream size function, and a target start-up delay is determined for serving the data stream; and
the block partition is determined with a reduced transmission bandwidth that ensures uninterrupted presentation of the data stream, given the cumulative stream size function and the target start-up delay.

33. The apparatus of claim 29, wherein
a communication link for serving the data stream is defined by a cumulative link capacity function, and a target start-up delay is determined for serving the data stream; and
the block partition is determined with a highest quality encoding of the data stream, from a set of possible encodings, that ensures uninterrupted presentation of the data stream, given the cumulative link capacity function and the target start-up delay.

34. An apparatus configured to determine a global block partition for serving a data stream of bits from a transmitter to a receiver, the data stream defined by a global cumulative stream size function and having a plurality of seek-points, each seek-point being a point in the data stream where the receiver can begin consuming the data stream within a predetermined start-up delay, the apparatus comprising:
means for dividing the data stream into a plurality of seek-blocks, each seek-block defined by a respective local cumulative stream size function, wherein data on one side of a particular seek-point is decoding independent of data on another side of the particular seek-point;
means for recursively defining, for each seek-block of the plurality of seek-blocks, a respective effective start-up delay that is less than or equal to the predetermined start-up delay;
means for determining, for each seek-block of the plurality of seek-blocks, a local block partition that ensures uninterrupted presentation of the respective seek-block with the respective effective start-up delay; and
means for determining the global block partition as the local block partitions of each seek-block of the plurality of seek-blocks in the data stream.
